(19) United States
(12) Patent Application Publication
(10) Pub. No.: US 2006/0075458 A1
(43) Pub. Date: Apr. 6, 2006

(54) Method of displaying an interactive content

(75) Inventors: Michel Lucas, Bussy Saint Georges (FR); Bruno Margerand, Issy Les Moulineaux (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/526,183

(22) PCT Filed: Aug. 22, 2003
(86) PCT No.: PCT/IB03/03817

§ 371 Date: Mar. 1, 2005

(30) Foreign Application Priority Data
Sep. 4, 2002 (FR) 0210927

(51) Int. Cl. H04N 5/445; G06F 13/00; H04N 7/16; H04N 7/084; G06F 3/00; H04N 7/087

(52) U.S. Cl. 725/139; 348/563; 348/473; 725/135; 725/40; 725/37; 725/52

(57) ABSTRACT

The invention relates to a method of displaying elements (31, 32, 33, 34) of an interactive content on a screen intended to display data transmitted in a digital television format comprising subtitles, by means of a command interface comprising a plurality of inputs. The elements of the interactive content are comprised in interactive subtitles, an interactive subtitle being associated with a link table indicating at least one correspondence between an input of the command interface and another subtitle. A subtitle based on an interactive subtitle is displayed by activating the input of the command interface corresponding to this subtitle.

### FIELD OF THE INVENTION

The invention relates to a method of displaying at least one element of an interactive content on a screen intended to display data transmitted in a digital television format comprising subtitles, by means of a command interface comprising a plurality of inputs.

The invention also relates to an audiovisual device for conceiving an interactive content and to a data processing system for processing an interactive content.

The invention finds its application in a digital television system, for example, in the television system based on the DVB standard (DVB is the abbreviation of Digital Video Broadcasting).

### BACKGROUND OF THE INVENTION

In television systems, additional information may be transmitted with an audiovisual content. This is, for example, information relating to broadcast programs, sports results, weather reports. This additional information is transmitted in the form of an interactive content which comprises elements, enabling a user to navigate from one element to another by means of a command interface, for example, a remote control unit.

FIG. 1 shows an example of such an interactive content. This interactive content comprises elements 11 to 16 which are accessible from a root element 10. A user accesses the root element 10, for example, by activating a predetermined key on his remote control unit. The root element 10 is displayed on the screen of the user. To access another element from this root element 10, the user must activate the key of his remote control unit corresponding to the desired element. For example, by activating the key “2”, the user gets access to the element 13 which is then displayed on the screen in the place of the root element 10. By activating the key “2” again, the user gets access to the element 14.

Such an interactive content is generally realized by way of teletext. For example, in the digital television format DVB, an interactive content in the teletext format is digitized and transmitted with the audiovisual data in accordance with the EN 300 472 standard: “Digital Video Broadcasting—Specification for conveying ITU-R System B Teletext in DVB bit streams”, the teletext format being defined by the EBU SPB 492 standard: “Teletext Specification (625-line television system)”.

A drawback of teletext is that the elements of an interactive content in the teletext format have a limited number of colors, generally 16, which makes them less attractive. Moreover, the elements of an interactive content in the teletext format generally cover the whole screen and do not have any transparency so that it is not possible to simultaneously visualize on a screen an element of the interactive content and audiovisual data such as a television program. On the other hand, the teletext format allows interactive contents to be only conceived in the form of texts, which renders such an interactive content less convivial. In other respects, the transmission of an interactive content in the teletext format necessitates a considerable rate occupying a large passband, which is a drawback because the passband in digital television systems is limited.

### OBJECT AND SUMMARY OF THE INVENTION

It is an object of the invention to provide a method of displaying at least one element of an interactive content, which does not have the above-mentioned drawbacks.

A method of displaying at least one element of an interactive content according to the invention and as described in the opening paragraph is characterized in that an element of the interactive content is comprised in an interactive subtitle, an interactive subtitle being associated with a link table indicating at least one correspondence between an input of the command interface and another subtitle, a subtitle being displayed from an interactive subtitle by activating the input of the command interface corresponding to this subtitle.

The invention benefits from the fact that, in the digital television formats comprising subtitles, these subtitles have functionalities which are further developed than teletext. For example, the DVB subtitles defined in the ETS 300 743 standard: “Digital Video Broadcasting (DVB); Subtitling systems” comprise pages which are displayed on the screen, a page comprising one or several regions. Each region is characterized by its dimensions, its position on the screen, a filling color and a maximum number of colors which may get as far as 256. In each region, graphical objects may be placed, which objects may comprise parts having a certain degree of transparency. Consequently, such a subtitle may be conceived in such a way that it comprises a considerable number of colors, is displayed in a desired space on the screen and comprises graphical objects of any nature with certain degrees of transparency.

In other respects, the transmission of such subtitles requires a rate which is not so high as for the transmission of a content in the teletext format. Indeed, for the example of the DVB television format, the transmission rate of subtitles is limited to 192 kilobits per second, whereas it generally reaches 300 kilobits per second for teletext.

According to the invention, the elements of the interactive content are comprised in subtitles, referred to as interactive subtitles. The interactive content thus has the same properties as the subtitles. Consequently, the interactive content may be composed of graphical objects of any nature, having certain degrees of transparency. In other respects, the interactive content may comprise a large number of colors because it may be constituted by regions each of which may comprise 256 colors. On the other hand, the interactive content may have desired dimensions and a desired position on the screen. For example, it is possible that an element of the interactive content occupies only a small surface of the screen. Finally, the transmission of such an interactive content necessitates a rate which is not so high as that for teletext.

To allow interactivity between a user and the interactive content, an interactive subtitle is associated with a link table indicating at least one correspondence between an input of the command interface and another subtitle. When an element of the interactive content is displayed on the screen and the user activates an input of the command interface, for example, a key on a remote control unit, a new element is thus displayed, which element is comprised in the subtitle corresponding to said input of the command interface.

At least one of the elements of the interactive content is preferably a permanent page, defined by a particular page type. The display method according to the invention thus allows display of an interactive content of the same nature as an interactive content in the teletext format. Indeed, an interactive content has elements which do not vary in the course of time, such as the root element 10 in FIG. 1. According to the invention, such an element is an interactive subtitle comprising a single page, which is permanent, i.e. it may be displayed indefinitely on the screen. To this end, said page is defined by a particular page type indicating that this page is permanent. This allows distinction of a permanent page from a conventional subtitle page, which is displayed for a predetermined period of time.

Advantageously, said permanent page is transmitted in turns. When the interactive content comprises a large number of permanent pages, it is not possible to store all of these pages in a memory in order to be able to access them by means of the display method according to the invention. To alleviate this drawback, the permanent pages are transmitted in turns, i.e. they are transmitted in a repetitive manner in the course of time so as to enable a user to get access to them.

The invention also relates to an audiovisual device for conceiving an interactive content in a digital television format comprising subtitles, said audiovisual device comprising means for inserting the interactive content in interactive subtitles and means for associating an interactive subtitle with a link table indicating at least one correspondence between an input of the command interface and another subtitle.

The invention also relates to a system for processing data transmitted in a digital television format comprising subtitles, said processing system comprising means for decoding at least an interactive subtitle comprising an element of an interactive content, an interactive subtitle being associated with a link table indicating at least one correspondence between an input of a command interface and another subtitle, and means for displaying a subtitle on a screen as a function of an input of the command interface.

Advantageously, the processing system also comprises means for storing at least one element of the interactive content. This allows certain elements of the interactive content to be stored so that they can be accessed rapidly.

### BRIEF DESCRIPTION OF THE DRAWINGS

These and other aspects of the invention are apparent from and will be elucidated, by way of non-limitative example, with reference to the embodiment(s) described hereinafter.

In the drawings:

FIG. 1 is a block diagram illustrating an example of the interactive content;

FIG. 2 is a block diagram illustrating a communication network using the display method according to the invention;

FIG. 3 illustrates a succession of elements of the interactive content displayed by means of the display method according to the invention.

### DESCRIPTION OF EMBODIMENTS

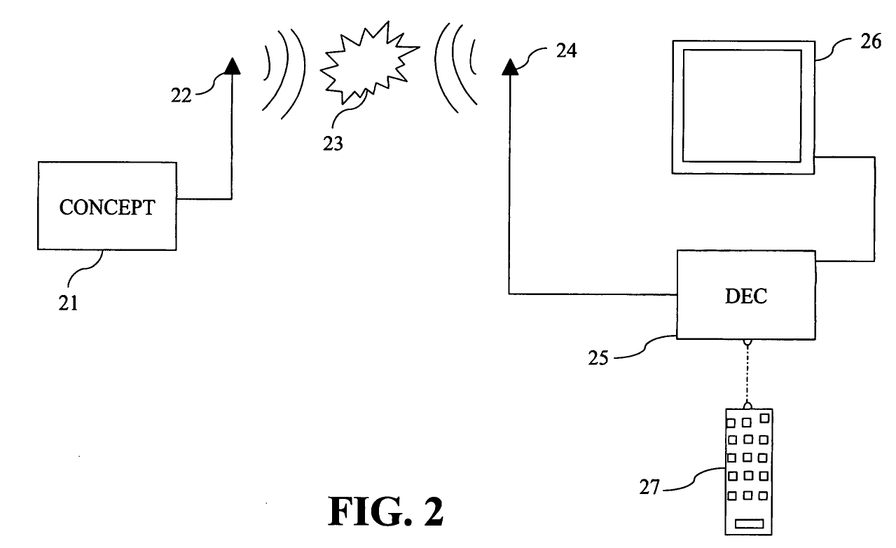

FIG. 2 illustrates a communication network using the display method according to the invention. Such a communication network comprises a conception device 21, a transmitter 22, a transmission network 23, a receiver 24, a data processing system 25, a screen 26 and a command interface 27. The example described hereinafter relates to the digital television format DVB using the subtitle standard ETS 300 743. However, the invention is applicable to other digital television formats comprising subtitles.

An audiovisual content is conceived by means of the conception device 21. Such an audiovisual content comprises video data, audio data, conventional subtitles and an interactive content in the form of interactive subtitles. The conventional subtitles are used, for example, for retranscribing the audio data as subtitles in order to facilitate comprehension by hearing-impaired people or for translating the audio data into a different language.

This audiovisual content is subsequently transmitted by the transmitter 22 to the receiver 24, via the transmission network 23. It should be noted that the transmitter 22 may form an integral part of the conception device 21. The transmission network 23 may be of a various nature, notably air in the case of radio transmission or optical fibers in the case of cable transmission.

After reception by the receiver 24, the audiovisual content is transmitted to the data processing device 25. The receiver 24 may form part of the data processing device 25. This is notably the case in a set top box.

The data processing device 25 decodes the video data, the audio data and the conventional subtitles and sends these decoded data to the screen 26 for display. The video data, the audio data and the conventional subtitles are thus displayed in so far as they are transmitted on the transmission network 23 and received by the receiver 24. It should be noted that the data processing device 25 and the screen 26 may form part of one and the same physical unit, for example, a digital television.

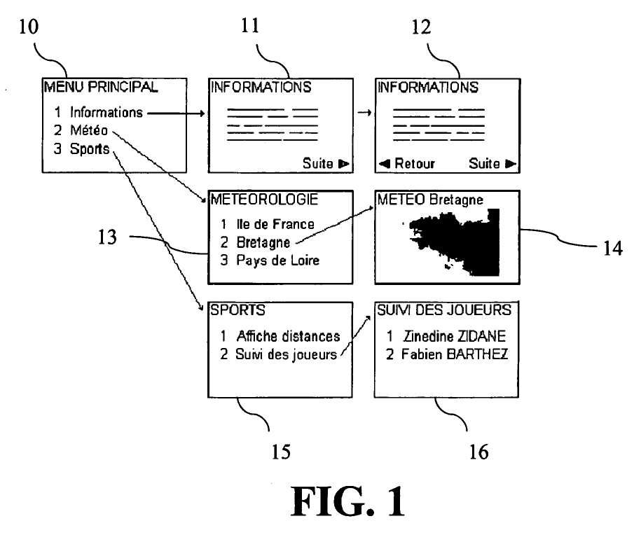

When a user wants to display an element of the interactive content, he activates a predetermined input of the command interface 27. A signal is then sent to the data processing device 25, indicating that a predetermined element of the interactive content must be displayed on the screen 26. This predetermined element corresponds to a root element of the interactive content, from which the user may reach other elements. By taking the example of the interactive content of FIG. 1 again, the predetermined element may be the root element 10. The predetermined input may be a key on the command interface 27 entitled, for example, “interactivity” or “menu”.

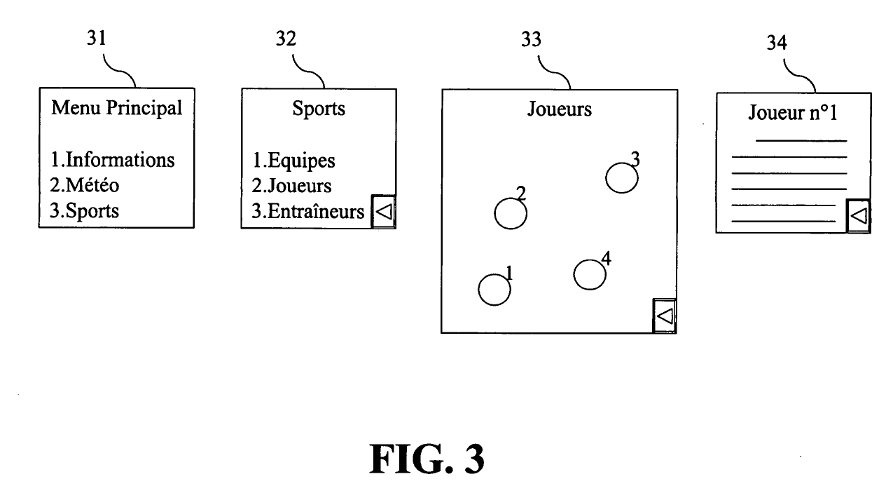

This signal generates the display of the interactive subtitle corresponding to the predetermined element of the interactive content, as will be described in detail with reference to FIG. 3. From this predetermined element, the user accesses another element by activating the input of the command interface 27 corresponding to this other element in the link table of the interactive subtitle comprising the predetermined element, as will be described in detail with reference to FIG. 3. This other element may be an interactive subtitle or a conventional subtitle. If this other element is an interactive subtitle, the user may reiterate this operation in order to get access to other elements.

It is important to note that the command interface 27 may have various shapes. It may be a remote control unit connected to the data processing device 25 by means of an infrared connection, command keys forming part of the data processing device 25 or any other device which is capable of generating a signal from a command input, notably a microphone and a voice processing device activated by the voice of the user.

FIG. 3 illustrates a succession of elements displayed by means of the display method according to the invention. In this example, a first element 31 of the interactive content is displayed by the user. To this end, the user activates a command input of his command interface, for example, by pressing the key entitled “interactivity” as described hereinbefore. The element 31 which is the root element of the interactive content is comprised in an interactive subtitle.

A subtitle is distinguished from other subtitles by a PID program number (PID=Program IDentifier) and an identifier “page_id”. Several subtitles may have the same PID program number; subtitles having the same PID program number are distinguished by their identifiers.

A standard PMT table (PMT=Program Map Table) comprises the program number and the identifier of a root element of the interactive content, i.e. the element 31 in this case. When the user presses the key entitled “interactivity”, the data processing device gets access to the PMT table. It then decodes all the subtitles having the same PID program number as the root element until it decodes a subtitle having the identifier of the root element, stored in the PMT table. This subtitle, which corresponds to the element 31, is then displayed on the screen.

The element of the interactive content 31 is comprised in an interactive subtitle comprising a single page. This page may comprise a text region comprising a transparent background and a region without text comprising a transparent background only. When the element 31 is displayed on the screen simultaneously with an audiovisual content such as a television program, the text of the element 31 is thus superimposed on the audiovisual content so that the user can continue visualizing the television program while having access to the textual information contained in the element 31.

In other respects, it is possible in accordance with the ETS 300 743 standard to place the interactive subtitle comprising the element 31 in an arbitrary part of the screen 26 and to give this interactive subtitle arbitrary dimensions. For example, such a subtitle may be placed in a corner of the screen 26 so that it does not hinder the visualization of the television program.

The element 31 is a permanent page, i.e. it stays on the screen as long as the user does not require the display of a new page. Generally, a subtitle comprises several pages which are displayed on the screen for a predefined period of time, for example, of the order of several seconds. A page is characterized by an instant at which it is displayed and an instant at which it ceases to be displayed. This is the case with a page of a conventional subtitle with which a page type “page_type” is associated, indicating that this page comprises an instant at which it is displayed and an instant at which it ceases to be displayed. In the ETS 300 743 standard, the page types “0”, “1” and “2” are used for characterizing such pages.

To create a permanent page, a particular page type is associated with the page of the interactive subtitle comprising the interactive element 31. For example, the page type “3” may be associated with a permanent page. The conception device 21 associates this particular page type with all the permanent pages of the interactive subtitles. When the data processing device 25 decodes such a permanent page, the particular page type indicates that this page must stay on the screen as long as the user does not require the display of a new page.

A permanent page, such as the element 31 of the interactive content, may be stored in the data processing device 25 by storage means. When the user wants to have renewed access to said permanent page, the access to this page is thus rapid. Particularly, it is advantageous to store the root element 31 because this element has a relatively high access frequency because the user has access to this element as soon as he wants to display elements of the interactive content.

However, such storage of permanent pages requires a considerable memory so that it is not always possible to store all the permanent pages of the interactive content. To remedy this problem, the permanent pages are transmitted in turns, i.e. they are transmitted in a repetitive fashion to the data processing device 25. For example, a permanent page may be transmitted every second. When the user wishes to have access to this permanent page and when he activates the input of his command interface corresponding to this permanent page, this page will thus be displayed within a period of time which is shorter than one second. In order that too long display times are not generated, the permanent pages are transmitted in turns at a sufficiently high transmission frequency, for example, once per second. However, to avoid cluttering up the transmission network, it is possible to transmit the permanent pages having a lower access frequency at a lower transmission frequency.

The interactive subtitle comprising the element of the interactive content 31 is transmitted with a link table indicating at least one correspondence between an input of the command interface and another subtitle. This link table is created by the conception device 21. In the example of FIG. 3, this link table allows establishing the correspondences defined in Table 1 below.

TABLE 1
correspondence between input of the
command interface and subtitles

| Input of the command interface | Subtitle |
|---|---|
| 1 | Information |
| 2 | Weather report |
| 3 | Sports events |

To get access to the element of the interactive content entitled “Information”, the user activates the key “1” of his remote control unit. To get access to the element 32 of the interactive content, entitled “Sports events”, the user activates the key “3” of his remote control unit.

Table 2 gives an example of the link table associated with the interactive subtitle comprising the element of the interactive content 3 1, which link table complies with the syntax defined by the ETS 300 743 standard. This link table is comprised in a segment of the interactive subtitle comprising the element 31 of the interactive content, which segment is entitled “link_information_segment”.

TABLE 2
link table

| | Syntax | Value |
|---|---|---|
| | link_information_segment | |
| { | | |
| | Sync_byte | 0000 1111 |
| | segment_type | 0x14 |
| | Page_id | 0x500 |
| | segment_length | 1011 |
| | { | |
| | key_code | 0x01 |
| | reserved | 111 |
| | Page_PID | 0xA5 |
| | Page_ID | Ox501 |
| | } | |
| | { | |
| | key_code | 0x02 |
| | reserved | 111 |
| | Page_PID | 0xA5 |
| | Page_ID | Ox502 |
| | } | |
| | { | |
| | key_code | 0x03 |
| | reserved | 111 |
| | Page_PID | 0xA5 |
| | Page_ID | Ox503 |
| | } | |
| | } | |

In this link table, the values entitled “key_code” correspond to the inputs of the command interface. Table 3 gives examples of such values for a key-operated remote control.

TABLE 3
values corresponding to the inputs of the command interface

| Value “key_code” | Input of the command interface |
|---|---|
| 0x00 to 0x09 | Digital keys 0 to 9 |
| 0x0A | Key ▴ |
| 0x0B | Key ▾ |
| 0x0C | Key [symbol] |
| 0x0D | Key [symbol] |
| 0x0E | OK/validation key |
| 0x0F | start/end key |
| 0x10 | red key |
| 0x11 | green key |
| 0x12 | yellow key |
| 0x13 | blue key |
| Other values | Reserved |

In the link table shown in Table 2, the value entitled “segment_type” allows distinction of the link table of other elements constituting a subtitle.

The values “page_PID” and “page_ID” associated with an input of the command interface correspond to the program number and to the identifier of the subtitle corresponding to said command input. It should be noted that a command input may correspond to a conventional subtitle, i.e. a subtitle not comprising a link table, for example, a subtitle comprising the retranscription of the audio band in a language different from that of the audio band.

In the example of FIG. 3, the user activates the key “3” of his remote control unit so as to get access to the element 32 of the interactive content, entitled “Sports events”. A signal is then generated, comprising the value “key_code” corresponding to this key. The processing device 25 then determines the program number and the identifier of the subtitle corresponding to this value “key_code” by means of the link table associated with the interactive subtitle comprising the element 31. In the example of the link table of Table 2, the program number and the identifier of this subtitle are:

page_PID=0×A5

page_ID=0×503

The processing device 25 then decodes all the subtitles having the value 0×A5 as their program number until it decodes the subtitle having the identifier 0×503. This subtitle is then displayed on the screen and corresponds to the element 32 of the interactive content, entitled “Sports events”. This element of the interactive content is also a permanent page.

The user subsequently gets access to the element 33 of the interactive content, entitled “Players” by activating the key “3” of his remote control unit. This element of the interactive content comprises markers with which players in a sports game can be identified so as to enable the user to obtain information on one of the marked players. The markers are identified by a number, 1 to 4 in this example. This element of the interactive content 33 is superimposed on an audiovisual content representing the sports game and the markers are displaced across the screen simultaneously with the marked players. Consequently, the interactive subtitle comprising this element of the interactive content is not a permanent page but comprises a succession of pages, each being characterized by an instant at which it is displayed and an instant at which it ceases to be displayed. Such a subtitle is thus not transmitted in turns, but is transmitted in synchronism with the audiovisual content representing the sports game.

The interactive subtitle comprising the element 33 of the interactive content comprises a link table. In the example of FIG. 3, the user activates the key “1” of his remote control unit in order to access information concerning the player marked by the marker identified by number 1, said information being comprised in the element 34 of the interactive content.

Use of the verb “comprise” and its conjugations does not exclude the presence of elements other than those stated in the claims. Use of the article “a” or “an” preceding an element does not exclude the presence of a plurality of such elements.

1. A method of displaying at least one element of an interactive content on a screen intended to display data transmitted in a digital television format comprising subtitles, by means of a command interface comprising a plurality of inputs, said method being characterized in that an element of the interactive content is comprised in an interactive subtitle, an interactive subtitle being associated with a link table indicating at least one correspondence between an input of the command interface and another subtitle, a subtitle being displayed from an interactive subtitle by activating the input of the command interface corresponding to this subtitle.

2. A method as claimed in claim 1, characterized in that the digital television format is the DVB format and the interactive subtitles are DVB subtitles.

3. A method as claimed in claim 1, characterized in that at least one of the elements of the interactive content is a permanent page, said permanent page being defined by a particular page type.

4. A method as claimed in claim 3, characterized in that said permanent page is transmitted in turns.

5. An audiovisual device for conceiving an interactive content in a digital television format comprising subtitles, said audiovisual device comprising means for inserting the interactive content in interactive subtitles and means for associating an interactive subtitle with a link table indicating at least one correspondence between an input of the command interface and another subtitle.

6. A system for processing data transmitted in a digital television format comprising subtitles, said processing system comprising means for decoding at least an interactive subtitle comprising an element of an interactive content, an interactive subtitle being associated with a link table indicating at least one correspondence between an input of a command interface and another subtitle, and means for displaying a subtitle on a screen as a function of an input of the command interface.

7. A data processing system as claimed in claim 6, said processing system also comprising means for storing at least one element of the interactive content.

8. A set top box comprising a processing system as claimed in claim 6 or 7.

9. A communication network comprising at least a transmitter suitable for transmitting signals representing at least an interactive content, a transmission network, a receiver suitable for receiving said signals and a data processing system as claimed in claim 6.

10. A digital television signal comprising elements of an interactive content in the form of interactive subtitles, an interactive subtitle being associated with a link table indicating at least one correspondence between an input of a command interface and another subtitle.
